(19) United States
(12) Patent Application Publication
(10) Pub. No.: US 2006/0190107 A1
(43) Pub. Date: Aug. 24, 2006

(54) System and method for feedback from mass mail marketing

(76) Inventors: Ami Kassar, Ambler, PA (US); Barak Kassar, San Francisco, CA (US)

Correspondence Address: STUART RUDOLER LLC;ATTN: DOCKET CLERK, 2 BALA PLAZA, SUITE 300, BALA CYNWYD, PA, 19004, US

(21) Appl. No.: 11/138,974

(22) Filed: May 26, 2005

Related U.S. Application Data
(60) Provisional application No. 60/626,575, filed on Nov. 10, 2004.

(51) Int. Cl. G06F 17/00

(52) U.S. Cl. 700/90

(57) ABSTRACT

The invention is a system and method for detecting whether a piece of direct mail marketing has been read by a recipient. The invention includes a novel envelope with an embedded sensor to detect whether it has been opened and a transmitter to send information from the sensor to a receiver, which in turn sends the information to a central computer. In the preferred embodiment this information is aggregated in a central computer and can then be analyzed to provide information about particular recipients, a group of recipients or about the effectiveness of a particular direct mail campaign.

### CROSS REFERENCE TO RELATED APPLICATION

This application claims the benefit of U.S. Provisional Patent Application Ser. No. 60/626,575 filed on Nov. 10, 2004, which is incorporated herein in its entirety by reference.

### BACKGROUND OF THE INVENTION

Direct mail marketing is the second largest form of advertising in the United States with companies spending 50 billion dollars on direct mail in 2003.

Direct mail marketing is almost always employed as a “direct response” advertising medium. In other words, the goal of direct mail marketers it to elicit a specific response from the recipient of what is called a direct mail piece (for example, letters, brochures or postcards). The hoped-for response typically involves the recipient sending back an order form, telephoning the advertiser or agent, or using the Internet to request more information about or to try or purchase a product or service.

The better direct mail marketers are at gathering and processing intelligence on individual recipients or groups of recipients, the more profitable the direct mail marketing campaigns will be. Direct mail marketers put a tremendous emphasis on the gathering of intelligence on individual recipients and groups of recipients to whom they send direct mail, and on maintaining that information in a database. Recipients may be consumers or businesses.

Much of the intelligence is gathered over the course of several mailing campaigns. For example, if a recipient purchases one or more products, that information is added to that recipient record in the database. This affects when and what direct mail pieces the advertiser will mail to that consumer in the future.

Direct mail marketers are able to gather a great deal of information from recipients who respond to their mailings. However, very few recipients who are sent a direct mail piece actually respond. According to the Direct Marketing Association, the industry group that represents direct mailing companies, the average number of people who respond to a direct mail campaign is 2.73 people out of every 100 people to whom the mail was sent. This averages across mailing for products and services in twenty-five major industries. The association includes letters, brochures, pamphlets and flyers in the statistics. For certain industries, such as credit card solicitations, the response to direct mail solicitations is below 1%.

The problem with the current state of the art is that approximately 97% of potentially useful information never makes it back in the direct mailer. This is because 97% of recipients do not initiate contact with the direct mailer in any way. The advertiser, therefore, has no way to differentiate between recipients who were absolutely not interested in the offer and those who were very interested but did not have time to respond—even though the advertiser would want to follow up with these two groups of recipients in very different ways. All the direct mailer can do is mark the date in the database records of these 97 out of every 100 people to say that they did not respond to a certain mailing. This is not very useful, especially considering that this accounts for almost every person to whom the mailer was mailed. Correspondingly, the vast majority of the money invested in creating a direct mail piece—including design, printing, paper and postage—is spent on these 97 out of 100 people from whom no information can be gathered.

In certain other advertising media, advertisers are able to better measure the response of their audience. For instance, electronic mail advertisers are able to calculate (i) who read their e-mail, (ii) how long they spent reading their e-mail, (iii) who opened it, read portions or elements of it, and discarded it, and (iv) who discarded it without opening it. Similarly, Internet advertisers are able to calculate precisely the number of individuals that “click through” their ads to see the advertisement and/or their website. Once an Internet advertiser has the potential customer at their website it is further able to calculate the exact interaction with the user and respond in real time to user requests. Internet operators use techniques such as data mining to understand exactly what types of advertisements work and for which consumers and to create databases of such consumers.

Direct mail advertisers have attempted to use Internet techniques by providing recipients with incentives to respond to direct marketing through their websites. In this model, a direct marketer mails a solicitation to a potential customer and if the customer wants to, he or she can respond using the Internet or email. Still in such embodiments the direct marketing advertiser does not have any more information about the 97% of recipients who simply discard the advertisements.

In a similar technique, some companies provide incentives within their products to go to the Internet and register as a user of the product. Such incentives include free coupons, frequent flyer points, cash incentives and free prizes. Once the potential customer is at the advertiser's website the advertiser can use many techniques to improve customer loyalty and to gain knowledge about the customer. Again, in such embodiments the direct marketing advertiser does not receive any more information about the recipients who do not respond.

In another medium, cable or satellite television transmission, it is known in the art to use a digital video recorder such as Tivo® to monitor what television shows and commercials a customer is recording and how they view those shows and advertisements. These devices are able to measure whether or not a viewer watched an advertisement, how often they repeated watching it, and at what point they stopped watching it. In addition, certain services related to digital video recorders have the ability to provide advertisements based on what a viewer is watching. The data from the digital video recorder is sent back to a central server and the information is aggregated into a database. In some cases this data is viewer specific and in other cases the data is aggregated across viewers.

It is also known in the art to install a device in a viewer's home that attaches to the television and automatically transmits to a central computer the information regarding what television shows the viewer is watching. Such a technique is used for the well known Nielson® ratings. While this technique is effective, it requires that the advertiser gain the consent of the viewer in order to monitor these responses.

It is well known in the field to track mail delivery through the postal system using mail sorters and scanners installed at large direct mail advertisers, their agencies and the postal service itself. Envelopes are printed with a machine-readable PLANET code that looks much like a bar-code. The limitations of the PLANET code system are tremendous. The codes cannot measure or report consumer's activity with the a piece of mail. The codes simply say where the mail is in the system until the mail leaves the post office. It does not carry through to the recipient.

It is desirable therefore to develop a system for detecting recipient responses to direct mail advertising.

### BRIEF DESCRIPTION OF THE INVENTION

The invention is a system and method for detecting whether a piece of direct mail marketing has been read by a recipient. The invention includes a novel envelope with an embedded sensor to detect whether it has been opened and a transmitter to send information from the sensor to a receiver, which in turn sends the information to a central computer. In the preferred embodiment this information is aggregated in a central computer and can then be analyzed to provide information about particular recipients, a group of recipients or about the effectiveness of a particular direct mail campaign.

### BRIEF DESCRIPTION OF THE FIGURES

FIG. 1 is a high level diagram showing the invention

FIG. 2 is block diagram of a specialized envelope used in the invention.

FIG. 3 is an example of one implementation of an envelope.

FIG. 4 is an example of an in-house network capable of interfacing with an envelope.

FIG. 5 is a table describing advertisements, responses and actions using the method of the invention.

FIG. 6 is a table describing current wireless communication technologies and each can be implemented with the invention.

### DETAILED DESCRIPTION OF THE INVENTION

The invention is a system and method for detecting whether a piece of direct mail marketing has been read by a recipient. The invention includes a novel envelope with an embedded sensor to detect whether it has been opened and a transmitter to send information from the sensor to a receiver, which in turn sends the information to a central computer. In the preferred embodiment this information is aggregated in a central computer and can then be analyzed to provide information about particular recipients, a group of recipients or about the effectiveness of a particular direct mail campaign.

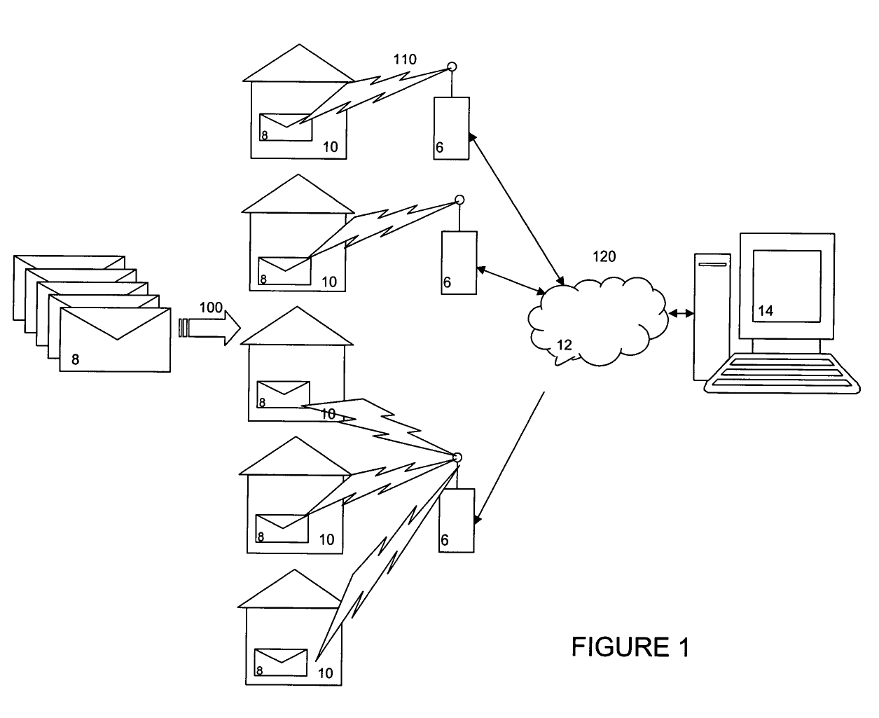

FIG. 1 shows a high level diagram of one embodiment of the invention. Each aspect of the invention shown in FIG. 1 may have many embodiments and will be covered in more detail later in this description. A number of direct mail pieces 8 including a means for sensing and transmitting recipient interaction are distributed 100 to recipient locations 10. The direct mail pieces 8 will be referred to herein as envelopes, however the term “envelope” includes all types of mass mailings such as traditional envelopes, postcards, boxes and folded flyers (such as bi-folds and tri-folds). The term envelope includes both the outside wrapper itself as well as the contents of the wrapper, such as the marketing information. The terms “direct mail” and “envelope” are not meant to be limited to only items sent through the postal service but also includes pieces distributed 100 to locations in other ways such as through newspaper or magazine inserts, courier service or hand distribution. Likewise the term “location” means any place to which direct marketing mail may be sent, including a single family detached houses, multiple dwelling units, apartments or a places of business.

Once in the location 10 the envelope 8 is handled by a recipient at the location 10. It may be opened and read, discarded and thrown away without opening, opened and thrown out without reading, shredded, or a recipient may actively respond to the direct mail offer (for example, by filling out a reply card, calling a toll free number, or accessing information via email or the Internet). The envelope 8 includes a sensor that detects at least some of the recipient responses and wirelessly transmits 110 this response to a receiver 6. As shown in FIG. 1, a single receiver 6 may cover a single or multiple locations 10. The receiver 6 may be situated inside or outside of the locations 10. The receivers 6 may be dedicated to receiving information from the envelopes 8, or they may be part of an existing communication network with which the transmitter in the envelope 8 is able to communicate.

Once the information from the envelope 8 has been transmitted 110 to the receiver 6, the receiver 6 then sends 120 this information through a communication network 120 to a computer system 14 for storage and processing. Direct mail marketers can then use the collected information to tailor future campaigns or to further target individual customers. It should be noted that the information transmitted does not have to be sent in real time but may be stored at any point in the chain and forwarded at an appropriate time.

The information collected from each envelope 8 may be particular to each location 10. In this embodiment, each envelope 8 is assigned a unique identifier. That unique identifier is linked in a database to the location 10 to which the envelope 8 is addressed, or even to a particular recipient within the location 10. The unique identifier may be assigned by a computer and that computer may or may not be part of the central computer system 14 which receives the responses. When an envelope 8 transmits 110 the response information back to a receiver 6 it also sends its unique identifier. This information (response and unique identifier) ultimately is sent 120 back to back to the computer system 14 which searches the database and uses the unique identifiers to link each response to a particular location 10 or recipient or group of recipients. In an embodiment where there is a unique receiver 6 for each location 10, the unique identifier may be embedded within the receiver 6 instead of the envelope 8. Alternatively, if a receiver 6 covers a certain geographic area (for example if the receiver were a wireless cell tower) the unique identifier may cover a number of locations 10 within a particular receiver's 6 geographic coverage.

In the previous paragraph it was noted that the unique identifier for an envelope 8 could be correlated to a particular recipient within a location 10. By way of example a direct mail marketer may wish to send several advertisements addressed to a man, woman or child in a house to determine which receives the most favorable response. Similarly, when the recipient is located within a business, the unique identifier may be coded by the type of employee the envelope is directed to, such as CEO, CIO, marketing manager or procurement agent.

In an alternative embodiment the information collected may only be aggregate information. This may be preferred either to reduce cost (since transmitting more information usually has an increased cost) or to protect privacy. In this embodiment the information collected is only that a certain number of responses of a particular type occurred. This may be for the total mass mailing or it may be broken down geographically or by other criteria chosen by the direct mail advertiser. Likewise instead of unique identifiers, the envelopes may contain certain identifiers that are not unique. For instance an envelope 8 could transmit 110 a code indication whether it was mailed to a household 10 with income above or below a certain threshold, sent to a business of a certain type or employee of a certain level, mailed to a woman or man, mailed to a particular geographic location, mailed to ethnic background, or any other grouping the direct marketer chooses. Thus, as used herein, aggregate means any information that is grouped together at a level higher than the location 10 it comes from. As mentioned above, aggregate data sorted by geography can be collected from the receiver 6 rather than through coding in the envelope 8.

In one desirable embodiment a recipient can actually affirmatively respond using an envelope 8. In the simplest form the envelope can contain an advertisement that states “Press Here If You Would Like To Receive Additional Information.” A sensor can detect if the indicated area is pressed (or torn or colored in or any other means of affirmative indication). This information along with a unique identifier can than be transmitted 110 from the envelope 8 through a receiver 6 and then on through the network 12 to the computer system 14. While with present technology the amount of data transmitted may be limited, improvements may allow even more information to be transmitted from the envelope and the invention is meant to incorporate such improvements. As another example, a credit card application may be able to filled out on paper and transmitted through the envelope 8 back to central computer system 14. In slightly less data-intensive version the recipient could simply write in an email address to which the marketer could send an electronic application.

In a further improvement to the invention, communication between the computer system 14 and the envelopes 8 may be two way. If an envelope 8 contained a screen or some form of electronic paper, a recipient may request additional information. The recipient could press an area of the paper indicating he/she desired further information. The envelope 8 may contain a number of areas to press on for requesting different information. The response along with the unique identifier is sent from the envelope 8 back to the computer system 14 as describe above. The computer system 14 then retrieves the requested information and sends it to the envelope 8. This may be done if the receiver 6 in FIG. 1 is also capable of transmitting. In this case, the computer systems send the requested information through the communications network 12 to the appropriate receiver/transmitter 6 which send the information back to the envelope 8. Alternatively, a separate transmission system may be used (not shown).

In the embodiment discussed in the previous paragraph the envelope 8 must contain some type of display mechanism. While conventional displays may be used, these are bulky and would be expensive to mail. So-called “electronic paper” is a technology currently in development by several research laboratories and private companies that has several embodiments-some of which are not paper per-se. Some electronic paper contains digital information embedded in it that can be scanned to identify the sender of the paper, other paper is actually perhaps better thought of as an extremely thin and flexible computer monitor and could, conceivably, in the future display news much as a news website does today. Such technology, or any other technology, can be used in the envelope 8 to display information sent from the computer system 14. This two way enabled mass mailing envelope would be of tremendous benefit to the direct mail advertiser. The advertiser would be able to get information about recipients and send recipients information they requested while the advertisement is still fresh in their minds. This provides the ability to “click through” to advertisements as is done already today on the Internet.

It should also be noted that the invention is not limited to traditional households or places of business but includes any location where mass marketing materials may be distributed. Thus envelopes 8 may distributed and an entertainment or sporting event, at a restaurant, or even on the street. In this sense the term “location” should be read to encompass any venue.

Having now described the invention at a system level it will be instructive to discuss each of the major components of the system: the envelope 8, including the embedded sensor and transmitter, the receiver 6, the communications network 12 and the computer system 14.

The Envelope

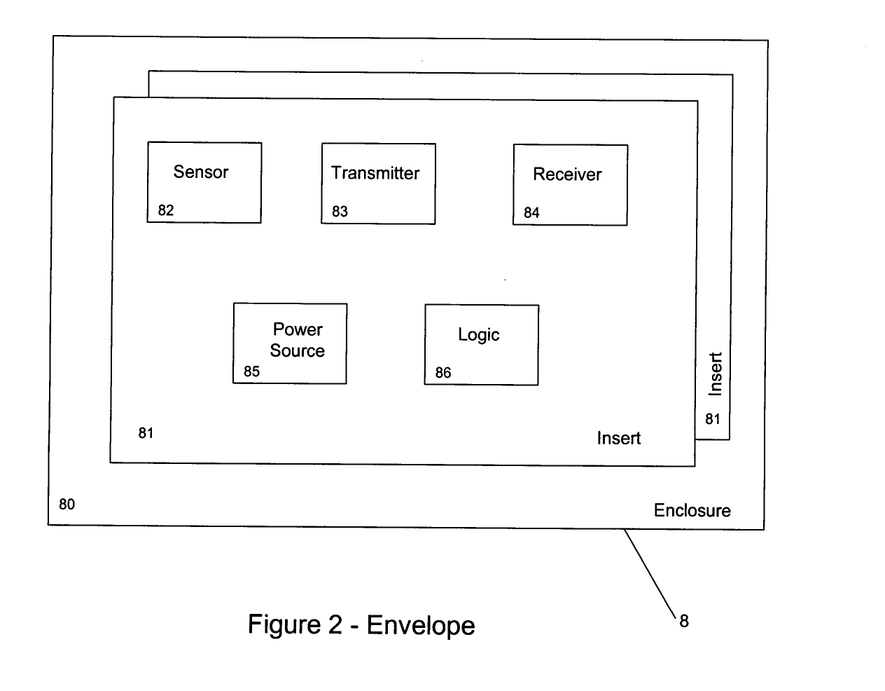

FIG. 2 shows a block diagram of the envelope 8. The envelope 8 is comprised of the printed material, which in most embodiments includes some enclosure 80 (but for instance in the case of a post card may have no enclosure), one or more inserts 81, a sensor 82 and a transmitter 83. The envelope may optionally include a receiver 84, a power source 85 and/or some logic 86. The term “enclosure” means the outside packaging of the mailer. Enclosures may take many forms other than a flat envelope, such as cardboard packages (of the type often used for overnight delivery), disk holders or cardboard or plastic tubes. The term “insert” means the internal material on which the advertisement is printed. The term “printed material” means either the enclosure 80 or the insert 81 or both. In some cases, such as a tri-fold, a leaflet or a postcard the insert 81 and enclosure 80 are one in the same. In fact, as described below, many of these functions can be combined into single devices. Likewise, items shown as being part of the insert 81 may be part of the enclosure 80. In addition, multiple inserts 81 may be included in one enclosure 80. An enclosure 80 might contain objects other than paper, they might contain other media used for direct mail marketing such as CD-ROMs, DVDs, VHS tapes, promotional gift items or any object.

The printed material may be traditional paper but it may also be any other material, including plastic, metal (such as aluminum foil), semi-conductor coated materials, flexible displays or any other medium on which a message can be printed or stored, as well as any combination of the foregoing. The printed material may actually be the sensor or power supply. The printed material may also be electronic paper (as described above) and “printed” should be understood to include electronic display or storage of information.

For example, if the enclosure 80 is made of aluminum foil (or plastic with a thin metal mesh embedded through it) it may be capable of damping any signal from the transmitter 83 inside. Therefore unless the enclosure 80 is opened, the envelope 8 cannot communicate with a receiver 6 and the lack of any signal indicates that the envelope 8 was never opened, or was ripped or shredded before opening. In this way the enclosure 80 is the sensor.

In another embodiment the insert 81 may be made of or coated with an optically sensitive material that reacts when exposed to light for a period of time. This change can be sensed by the transmitter 83 or logic 86 and transmitted to a receiver 6.

Alternatively, the insert 81 may be made of a solar cell which generates electricity when exposed to light. Such an embodiment might look to a recipient like a traditional CD or DVD with printed information on it. When power is generated from the solar cell the transmitter 83 is enabled to transmit information to the receiver 6. If the envelope 8 is thrown away or ripped or shredded before being opened (or even opened without the insert being unfolded) no power is sent to the transmitter 83 and the receivers 6 never get a transmission from that particular envelope 8. In this way, the insert 81 acts as the sensor 82, power source 85 and logic 86.

In one embodiment of the invention the transmitter 82 is a passive RFID tag such as those used in toll collection, security passes and speed payment at gasoline stations. RFID tags are also currently used to identify and track the location and movement of packages and inventory in factories, warehouses, stores and throughout the manufacturing/distribution chain. An RFID Tag is connected to a type of sensor 82 that can determine whether or not the envelope had been opened. One advantage of the passive RFID tag is that it does not require any power supply because it gets its energy from the receiving device which transmits a sufficiently strong RF signal for the RFID tag to respond (in this sense the RFID works like a mirror reflecting light). Other advantages of RFID tags is that they can be small and inexpensive.

Other types of possible transmitters 83 are active RFID tag, radio, Bluetooth, 802.11 (wireless network), ZigBee, cellular phone or pager data delivery, WIMAX, Ultra Wide Band, infrared, microwave, satellite or any other type of wireless communication technology whether now known or hereinafter developed. Preferable the transmitter 83 should be small and inexpensive, however these attributes should not be considered a limitation of the invention.

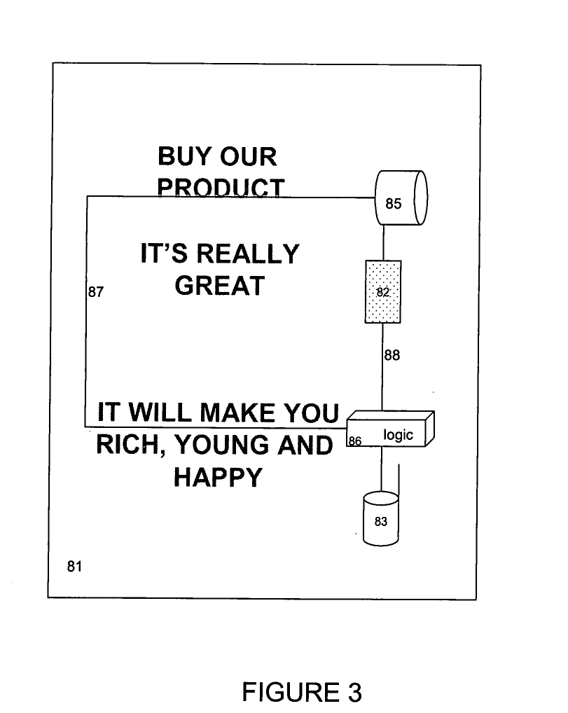

FIG. 3 shows one configuration of an insert 81 with advertising message. In this embodiment the power supply 85 is a battery. The sensor 82 is either sensitive to light or air. It may detect either that the enclosure 80 was opened, held by a recipient for a period of time, that an insert 81 was unfolded, or some combination of the foregoing. The battery 85 provides power to the sensor 82, logic 86 and transmitter 83 through an electrical connection 88. When the envelope enclosure is opened and the insert 81 is exposed to light, the sensor 82 sends a signal to the logic 86 which in turn transmits this information to the transmitter 83 which in turn sends the information to the receiver 6. A signal line 87 also is connected the power source to the logic 86 and runs across the insert 81 in such a way that the signal line 81 is likely to be broken if the insert 81 is ripped or shredded. Preferably the signal line 87 is brittle so that it will be broken if the insert 81 is crumpled. The logic 86 can detect if this signal line 87 has been broken. If the envelope is ripped or shredded the signal line 87 will be broken and the signal from the battery 85 to the logic 86 will end. The logic 86 can then determine if the signal line 87 was broken before or after the sensor 82 detected that the insert 81 was unfolded and transfer this information to the transmitter 83. The logic 86 may even contain a timer that measures the amount of time from when the sensor 82 detected that the insert 81 was unfolded or the enclosure 80 is opened until the signal line 87 is broken (indicating ripping). It will be obvious to those skilled in the art of electronics that there are many possible ways to run the signal line 87 and design the logic and such embodiments are meant to be within the scope of the invention. For example, the signal line 87 may run from an output of the logic 86 to an input of the logic 86.

In a simpler embodiment the signal line 87 may be attached from the insert 81 to the enclosure 80, such that removing the insert 81 from the enclosure 80 breaks the line. This indicates to the logic 86 that the envelope has probably been open. In such an embodiment a separate sensor 82 may not be needed, since the signal line 87 acts as a sensor.

It should be noted that a sensor need not be completely accurate. A direct marketing advertiser will most likely tolerate a significant number of false positive responses (i.e. incorrect indications that envelopes were opened) since even imperfect information will be better than what is currently available. In addition statistical methods may be applied to reduce the errors introduced by false positive responses.

Many types of sensors may be used in the envelope, including chemical, mechanical, acoustical, pressure, thermal, electrical, chemical or any combination of the foregoing. A thermal or pressure sensor that responds when a human being touched the paper or sensor area for a period of time is a particular attractive embodiment since it provides evidence that the insert was held for a period of time or whether non-folded or non-enclosed direct mail, such as a postcard or insert card, was read by a recipient. The sensor 82 may be either a discrete unit attached to the printed material or it may be integrated into the printed material. All types of sensors whether now known or discovered in the future are encompassed within the scope of this invention.

The logic 86 may be discrete logic or, more likely, an integrated circuit of some type. Preferably the logic will use thin film or other miniaturization techniques well known in the art so that it can be cheaply produced and is small and flexible. As discussed above, logic 86 may not be a discrete component but may be as simple as the presence or absence of a power source 85. However, the logic 86 may be quite complex and contain a unique identifier and have the ability to operate the transmitter 83 (and/or receiver).

The power source 85 will generally provide electrical power, if required, to the transmitter 83, logic 86 and sensor 82. As mentioned above, in the case of some technologies, such as passive RFID an included power source may not be necessary since the transmitter 83 takes its power from the external receiver 6. The power source may be chemical (i.e. a battery), solar, kinetic, thermal or any other technology now known or later invented. Preferably, in order to keep the power source as small as possible only a short burst of power will be required in order to operate the envelope while it senses the state and transmits information to the external receiver 6. In such an embodiment, a battery may be activated by the opening of the envelope 8 and operate for short time thereafter. However, if two way communication between the computer system 14 and the envelope 8 is to be accomplished a longer term source of power may be necessary.

While in one embodiment the sensor 82 merely detects whether or not the envelope has been opened or not, in a preferred embodiment the sensor 82 can provide more detailed information as to whether an insert 81 was unfolded, how long an insert 81 was held, whether certain sections were read, whether multiple persons reviewed handled the insert 81, or even if a response was requested. In one embodiment the sensor 82 (or sensors) can even allow the recipient to input data to be sent back to the advertiser. This feedback provided by the sensor will referred to herein as a “response.”

It will also be obvious to those skilled in the art of electronics and miniaturization that all or some of the power source 85, transmitter 83, receiver 84, sensor 82 and logic 86 may be integrated into a single device.

Transmission from Envelope to Receiver

Many technologies exist that will enable a transmission from an envelope 8 to a receiver 6 that can be connected to a communications network 12.

Conceptually, the transmission step 110 shown in FIG. 1 is straight forward. A certain amount of data resides in the envelope 8 and it is sent wirelessly to a receiver 6 that can connect to a communication network 12 (either by physical lines, wirelessly or docking station) through which the data can be sent 120 to a computer system 14 for processing. The amount of data may be a single bit, a few bytes, or gigabytes. A system with greater bandwidth (i.e. more data) generally is more expensive, but as costs for data transmission continue to drop this tradeoff may become irrelevant.

One important aspect of the system is whether to use a network of receivers already in place (such as cell phone towers) or rely upon specialized receivers that are not already in place. While it would be desirable to use existing infrastructure, generally such systems are more costly, in terms of dollars as well as complexity and size of the envelope, to interface with.

Wireless technologies are constantly changing and the particular examples set forth below for illustrative purposes are not meant to be limiting in any way. Indeed, the invention is meant to encompass all such technologies, whether currently existing or developed in the future. Similarly, certain implementations, while technically feasible today, may not be economically viable. However, as costs drop over time such implementations may become viable and the invention is meant to incorporate such improvements.

In one embodiment of the invention the envelopes 8 interface with existing cellular phone towers. The cellular phone towers act as receivers 6. In this embodiment, the envelope 8 incorporates a miniature cellular data device capable of dialing into a wireless phone system and delivering data. In this embodiment the power supply 85, logic 80 and transmitter 83 make up a cellular data device. Similar technology exists for wireless internet technology and can be likewise tapped into.

Certain areas of the country have publicly available Internet access over a certain geographic area. The Internet can be accessed via wireless access points from stationary computers or portable computers via wireless technology such as 802.11. These wireless access points are available throughout the geographic area. For example certain cities are deploying these networks with free open access placing wireless access points on top of light poles. The wireless access point act as receivers 6. In this embodiment the envelope 8 incorporates a miniature wireless card including the necessary protocol (today the TCP/IP protocol) to communicate over the Internet.

Similarly, while today prohibitive due to the power requirements and line of site needs, transmission to satellites may also be used.

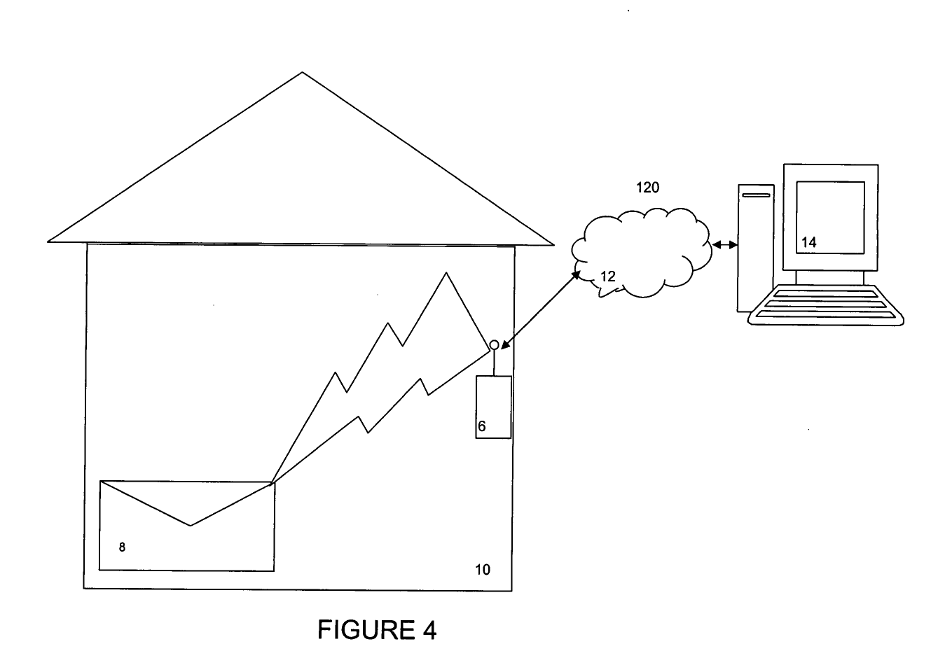

In one preferred embodiment the envelope 8 communicates with a receiver 6 in the location 10 as shown in FIG. 4. Many households and businesses already have a wireless network running throughout the house that provide direct access to the Internet. Currently 802.11 and Bluetooth are used for such purposes but all such locally deployed networks are meant to be incorporated herein. Although such networks may be password protected, in fact, today many people do not bother with such protection and the Internet may be freely accessed by any device in transmission range of the network. This embodiment has advantages in that the transmission power requirements are far lower since the receiver 6 is much closer. The disadvantage is that it may not be universally available.

In another variation of the home wireless network embodiment of the previous paragraph, the consent of recipients may be requested in advance. This might be desirable to provide a test audience of a certain demographic mix. In this case the direct marketer can provide specialized software to run on a local computer that would receive the information through the wireless network and then pass it on to the computer system 14.

In another embodiment involving recipient consent, a customized receiver 6 can be placed in each location 10. This receiver can be attached to a local AC power source or operated from relatively large batteries. The receiver 6 can communicate wirelessly, through phone lines, over the Internet or any other communication network 12 with the computer system 14. In this embodiment a relatively low power transmitter 83 can be placed in the envelope because the receiver 6 will be assured to be relatively close to where the recipient usually opens mail. Also, since a proprietary receiver may be used the receiver 6 and envelope 8 can be designed and optimized to minimize the size and cost of the transmission system in the envelope 8. Furthermore, the receiver 6 may be active, that is querying the envelope 8, instead of passively waiting for a transmission from the envelope 8. For example, the receiver 8 may also use the passive RFID technology discussed above to query an RFID tag inside an envelope in order to elicit a response. Such technology is readily available, small and inexpensive.

In another embodiment information is collected from envelopes through the trash collection system. When the mail is thrown away it is usually collected by a trash or recycling truck. A receiver aboard a trash truck transmits a signal to any passive RFID Tags in envelope the trash, and collects responses from each RFID tag that happens to be there. When queried by the trash truck receiver an RFID tag responds that its envelope has either been opened or not. The information from each trash truck 20 is then transmitted back to a central computer for processing. An alternative to using the trash collection system is to have mail carriers, utility readers or other service providers who pass by homes frequently carry receivers and query the envelopes in each house. Alternatively, special crews deployed by the mass marketer can travel past locations on public roads with the appropriate equipment to query envelopes. In this embodiment the receiver may be portable and can transmit the information it collects either wirelessly or through a docking station to another device that in turn connects to an appropriate communication network and passes on to the computer system.

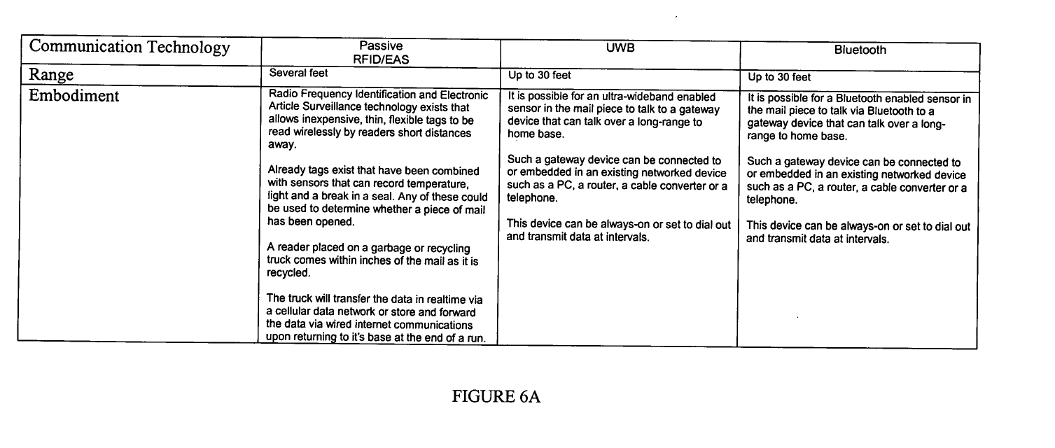

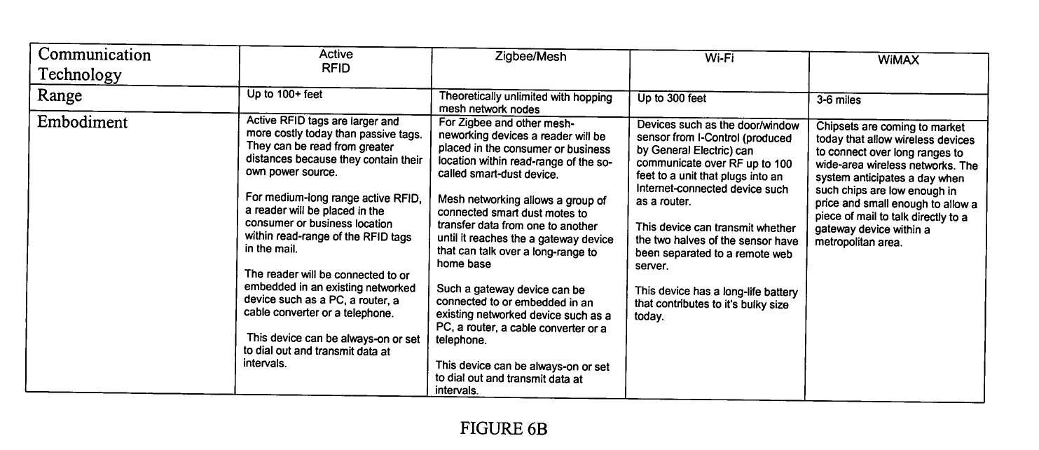

FIG. 6 lists a number of different wireless transmission technologies and how each would be implemented.

Communication Network and Computer System

The communication network 12 shown in FIG. 1 is any wide area communication network that would allow a plurality of receivers 6 to communicate with a computer system 14 operated by the direct marketer (or its agent). This may be any public or private system including the Internet, satellites, land based phone voice/data system, cable network, or wireless telephone/data systems. These technologies and standards are constantly evolving and the invention is meant to incorporate all such networks, regardless of technology, protocol or topology, whether now existing or developed hereafter.

The computer system 14 is comprised of one or more computers, data storage devices and software for receiving, storing, sorting, searching and acting upon the responses received from the envelopes 8. The computer system 14 components may be spread among multiple locations and owners.

In a preferred embodiment the computer system allows direct mail marketers to generate reports to measure and understand the effectiveness of specific direct mail campaigns with individual recipients or groups of recipients. The computer system 14 does this by correlating the information that identifies 1) each mail piece, 2) each recipient and 3) each recipient's actions with the mail piece. It is important to note that due to personal privacy matters, the system makes it possible to not gather personally identifiable data on individuals, but allows direct mail marketers to choose to gather aggregate data.

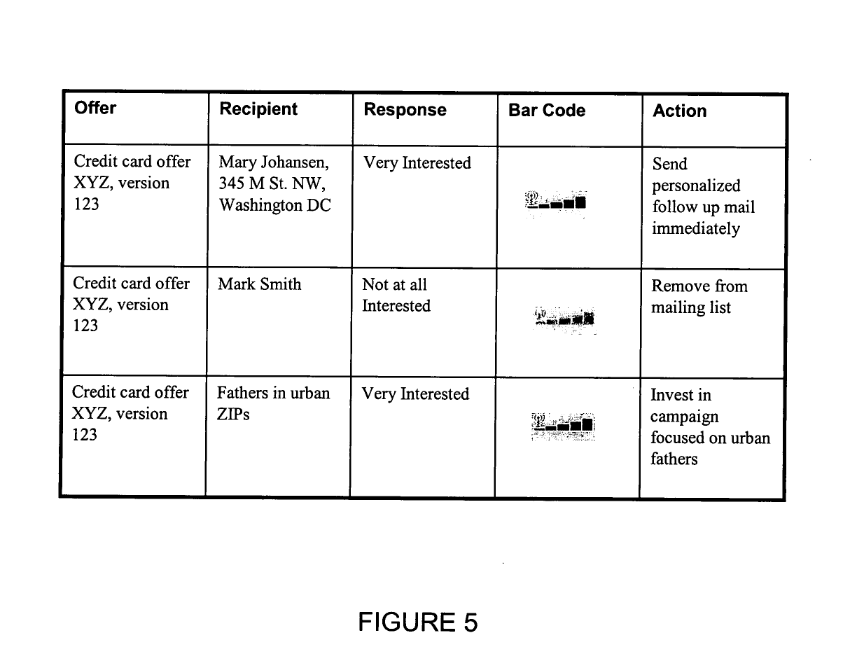

The computer system 14 may also quantify the quality of response provided for an particular recipient or demographic group. A direct mailer taking very different follow-up actions with each of these recipients or groups. The response may even be represented graphically, for instance with color codes or bar charts. In one embodiment responses are assigned numeric values by the computer system as follows:
1. Very interested (read every element of the piece and is saving it)
2. Interested (read every element of the piece and did discard it)
3. Medium interested (read some elements of the piece and discarded)
4. A little interested (opened but didn't really read)
5. Not at all interested (discarded without opening).
   FIG. 5 shows how an advertiser may use this information.

It is understood that the invention is not limited to the disclosed embodiments, but on the contrary, is intended to cover various modifications and equivalent arrangements included within the spirit and scope of the appended claims. Without further elaboration, the foregoing will so fully illustrate the invention, that others may by current or future knowledge, readily adapt the same for use under the various conditions of service.

We claim:

1. A system for retrieving information from a mass mailing comprised of:
an envelope distributed to a location, said envelope further comprised of:
printed material;
a sensor;
a transmitter;
a receiver in communication with the envelope;
a communication network in communication with the receiver; and
a computer system in communication with the communication network;
wherein the envelope detects a recipient response at the location and transmits this response to the computer system through the receiver and the communication network.

2. The system of claim 1 wherein the envelope is further comprised of an enclosure and an insert.

3. The system of claim 1 wherein the envelope is a postcard, bi-fold, tri-fold or flyer.

4. The system of claim 1 wherein the location is household or business.

5. The system of claim 1 wherein the transmitter uses passive RFID, active RFID, analog, digital, radio, microwave, satellite, Bluetooth, 802.11, Zigbee, WIMAX, infrared, ultra wide band, cellular or pager transmission technology.

6. The system of claim 1 wherein the sensor is electrical, mechanical, acoustical, optical, chemical or thermal.

7. The system of claim 1 wherein the receiver is located either inside or outside the location.

8. The system of claim 1 wherein the receiver is a portable device passing by the location.

9. The system of claim 1 wherein the receiver is an RFID reader, cellular telephone receiver, local wireless network hub or satellite.

10. The system of claim 1 wherein the envelope is further comprised of a power source.

11. The system of claim 10 wherein the power source is a battery or solar cell.

12. The system of claim 1 wherein there are a plurality of envelopes sent to a plurality of locations, said envelopes communicating responses from said locations to the computer system through a plurality of receivers and the communication network.

13. The system of claim 12 wherein each envelope has an identifier transmitted with the response, said identifier also being stored in a database to which the computer system has access.

14. The system of claim 13 wherein the identifier is unique to each location, recipient, location, geography or demographic.

15. A mass mailing advertisement comprised of:
an advertisement displayed on an insert;
an enclosure surrounding the insert;
a sensor for detecting a recipient response; and
a transmitter.

16. The system of claim 15 wherein the insert and the enclosure form one piece and are comprised of a postcard, bi-fold, tri-fold or flyer.

17. The system of claim 15 wherein the transmitter uses passive RFID, active RFID, analog, digital, radio, microwave, satellite, Bluetooth, 802.11, Zigbee, WIMAX, infrared, ultra wide band, cellular or pager transmission technology.

18. The system of claim 15 wherein the sensor is electrical, mechanical, acoustical, optical, chemical or thermal.

19. The system of claim 15 wherein the envelope is further comprised of a power source.

20. The system of claim 19 wherein the power source is a battery or solar cell.

21. A method for determining response to direct mail advertisement comprised of:
sending an envelope to a recipient, said envelope comprising an advertisement on printed material, a sensor for detecting a response and a transmitter;
the transmitter sending the response from the sensor to a receiver;
the receiver sending the information to a computer system through a communication network; and
the computer system outputting a report about the response.

22. The method of claim 21 wherein the recipient is a consumer or business.

23. The method of claim 21 wherein the transmitter uses passive RFID, active RFID, analog, digital, radio, microwave, satellite, Bluetooth, 802.11, Zigbee, WIMAX, infrared, ultra wide band, cellular or pager transmission technology.

24. The method of claim 21 wherein the sensor is electrical, mechanical, acoustical, optical, chemical or thermal.

25. The method of claim 21 wherein the receiver is a portable device carried by a service provider for the recipient.

26. The method of claim 21 wherein the receiver is an RFID reader, cellular telephone receiver, local wireless network hub or satellite.

27. The method of claim 21 wherein the envelope is further comprised of a power source.

28. The system of claim 27 wherein the power source is a battery or solar cell.

29. The method of claim 21 wherein there are a plurality of envelopes sent to a plurality of recipients, said envelopes communicating responses from said recipients to the computer system through a plurality of receivers and the communication network.

30. The method of claim 29 wherein each envelope is assigned an identifier, the identifier is transmitted with the response, the identifier is stored in a database to which the computer system has access, and the computer system uses the identifier in generation the report.

31. The method of claim 30 wherein the identifier is unique to each location, recipient, location, geography or demographic.

32. A method for determining response to direct mail advertisement comprised of:
sending an envelope with an advertisement through the mail to a recipient, the envelope including a sensor for detecting a response and a transmitter;
collecting the envelope or portion of the envelope from the recipient;
the transmitter sending information from the sensor to a receiver; and
the receiver sending the information to a computer system; and
computer system outputting a report about the response.

33. The method of claim 32 wherein the step of collecting is accomplished through trash collection and the trash collection truck contains the receiver.
